(19) United States
(12) Patent Application Publication
(10) Pub. No.: US 2007/0166508 A1
(43) Pub. Date: Jul. 19, 2007

(54) Drainage for sports surface

(76) Inventor: Gary Wayne Waterford, Double Bay (AU)

Correspondence Address: GORDON & JACOBSON, P.C., 60 LONG RIDGE ROAD, SUITE 407, STAMFORD, CT, 06902, US

(21) Appl. No.: 10/577,818

(22) PCT Filed: Nov. 1, 2004
(86) PCT No.: PCT/AU04/01510

§ 371 Date: Nov. 27, 2006

(30) Foreign Application Priority Data
Oct. 31, 2003 (AU) 2003906048

(51) Int. Cl. B05D 1/16

(52) U.S. Cl. 428/90

(57) ABSTRACT

The present invention provides a synthetic turf system (10) including: a drainage layer (14) including a first flexible backing sheet (22) and a plurality of synthetic tufts (24), the tufts (24) being attached to and extending upwardly from said first backing sheet (22); a water-permeable synthetic turf layer (12) disposed above the drainage layer (14), the turf layer (12) including a second flexible backing sheet (18) and a plurality of synthetic ribbons (20a, 20b, 20c) extending upwardly from said second backing sheet (18) to provide a playing surface, said second backing sheet (18) being water-permeable; and attachment means for attaching the synthetic turf layer (12) to the drainage layer (14). A layer of a granular in fill material (21) fills the voids between the ribbons (20a, 20b, 20c) in the synthetic turf layer (12).

### BACKGROUND OF THE INVENTION

The invention relates to a drainage system for a synthetic sports surface such as that simulating a turf or clay sports or recreation surface. The invention also relates to a synthetic sports and recreation surface with improved drainage characteristics.

Synthetic turf is known and widely used for recreational areas and for sporting pursuits such as tennis, lawn bowls, horse racing, hockey and football. Such synthetic turf surfaces are formed as a flexible backing sheet into which is stitched (tufted) parallel rows of synthetic ribbons which extend upwards of the backing sheet to simulate blades of grass. The ribbon length and thickness, the gauge between the rows, and the tufting rate between adjacent tufts in each row, will depend on the intended use of the surface. A backing layer, such as latex, may be applied to the back of the backing sheet.

A particulate material, such as one or more layers of sand or crumbled rubber, is used as an in fill material between the ribbons, to hold the ribbons generally upright and to provide resilience to the sports surface. The infill level typically extends to a short distance below the tips of the ribbons, so that the exposed ribbon tips resemble the appearance and playing characteristics of grass.

It is possible to simulate the playing characteristics of a clay tennis surface by means of a synthetic turf surface which is overfilled so that a layer of the granular infill material covers the tips of the synthetic pile. Furthermore, by appropriate colouring the infill material, the appearance of a clay court can also by simulated.

One of the problems common to most sports surfaces is the problem of drainage. To address this problem two types of drainage systems have been developed—surface drainage systems and sub-surface drainage systems.

A surface drainage system is usually used to redirect surface water that might otherwise flow over the sports surface, and to prevent accumulation of water beneath the surface. To this end, the sports surface is usually slightly elevated above the surrounding ground. In addition, to allow for drainage of the surface, the surface should slope approximately 0.2-1.2%, depending on the sport involved.

Due to restrictions of a near level surface, surface drainage alone is relatively slow and may fail to cope with heavy downpours.

To provide more efficient drainage properties, sub-surface drainage systems have been developed. Although such drainage systems provide a better solution in terms of the need for top-dressing, rolling, brooming, etc., installing a sub-surface drainage system (especially in an existing sports field) is very expensive.

Synthetic turf sports surfaces are popular as they often require less maintenance and give better playing characteristics than the equivalent grass or clay surface which they simulate. However, the synthetic turf surfaces do not in themselves improve the rate of drainage, and in the case of surfaces laid over a clay tennis court, for example, the original clay surface under a simulated clay surface can still become water-affected.

### SUMMARY OF THE INVENTION

The present invention aims to provide a synthetic sports or recreation surface with improved drainage characteristics.

A first form of the present invention provides a synthetic sports or recreation surface including
a drainage layer including a first flexible backing sheet and a plurality of synthetic tufts, said tufts being attached to and extending upwardly from said first backing sheet;
a water-permeable synthetic turf layer disposed above the drainage layer, said turf layer including a second flexible backing sheet and a plurality of synthetic ribbons extending upwardly from said second backing sheet to provide a playing surface, said second backing sheet being water-permeable;
attachment means for attaching said synthetic turf layer to said drainage layer,
a layer of a granular infill material filling the voids between the ribbons in the synthetic turf layer.

A second form of invention provides a synthetic sports or recreation surface including:
a drainage layer including a first flexible backing sheet and a plurality of synthetic tufts, said tufts being attached to and extending upwardly from said first backing sheet;
a water-permeable synthetic grass layer disposed above the drainage layer, said grass layer including a second flexible backing sheet and a plurality of synthetic ribbons, representing blades of grass, said synthetic ribbons being attached to and extending upwardly from said second backing sheet, said backing sheet being water-permeable;
attachment means for attaching said synthetic grass layer to said drainage layer,

Preferably said tufts in the drainage layer are loop pile tufts.

Preferably said synthetic loop pile tufts are tufted into said backing sheet.

Preferably said tufts are arranged in parallel rows, said tufts being tufted into the backing sheet at a gauge of about ¼″.

Preferably, the height of the synthetic loop pile tufts lies between 3 and 9 mm. More preferably, said height is about 5-7 mm.

In a preferred embodiment said loop pile tufts are made of polypropylene, polyethylene or a polypropylene and polyethylene blend. Preferably said tuft material is the form of a yarn.

Preferably said first backing sheet is latex-backed.

Preferably the first backing sheet is less water-permeable than the second backing sheet. Preferably the first backing sheet has a water permeability of less than 10%, more preferably about 3-5%.

Preferably said attachment means is a seaming tape.

Preferably said second backing sheet is micro-perforated. Preferably said perforation is uniform.

### BRIEF DESCRIPTION OF THE DRAWINGS

Further preferred embodiments will now be described with reference to the accompanying drawings, in which:

FIG. 1 is a schematic plan view of a drainage layer according to the present invention; and

FIG. 2 is a schematic sectional view of a tennis surface provided with the drainage layer of FIG. 1.

### DETAILED DESCRIPTION OF PREFERRED EMBODIMENTS

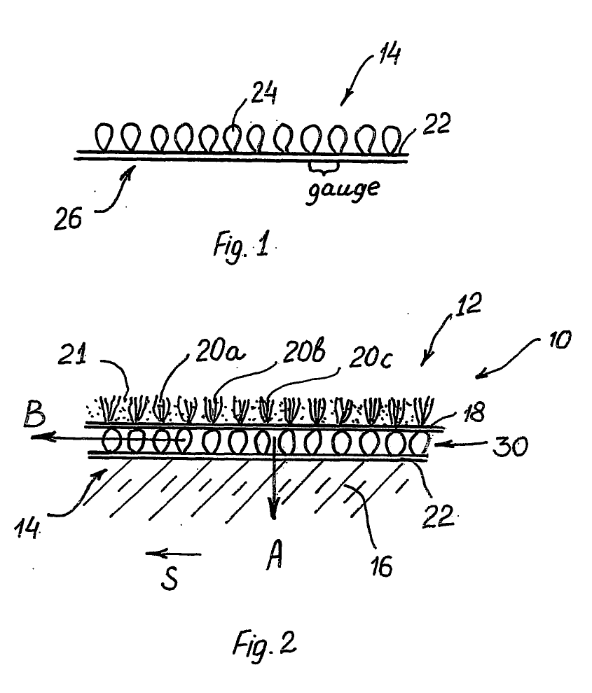

With reference to FIGS. 1 and 2, a simulated clay tennis surface 10 includes a water-permeable synthetic turf layer 12 and a drainage layer 14. The tennis surface 10 is laid on a supporting surface 16 such as the ground or a substrate of timber, concrete, bitumen or prepared crushed rock. The tennis surface 10 can also be laid over a ‘real’ re-conditioned clay court. To this end, the existing clay surface should be scraped and rolled to a desired fall.

To allow for the drainage of the tennis surface 10, the supporting surface 16 slopes approximately 0.5% in the direction indicated by ‘S’.

The synthetic turf layer 12 has a micro-porous backing sheet 18 of one or more layers, of the type typically used in manufacture of conventional synthetic turf, e.g. a water-permeable geotextile or a latex-backed woven polypropylene material. In the case of the latex-backed polypropylene backing sheet, to provide sufficient permeability the sheet is preferably micro perforated after latexing to form a series of fine (eg. 3 mm) holes uniformly over the entire surface of the sheet.

Parallel rows of synthetic ribbons 20 are tufted into the backing layer at a relatively open stitch rate of about 180-260 stitches per meter, and a gauge of about 3/16″ to ⅜″.

The particulate infill material 21, e.g. sand, is of consistent grain size and is coloured for example terracotta or green to match the appearance of the court-type which is being simulated.

The drainage layer 14 includes a flexible backing sheet 22.

Attached to the sheet 22 are parallel rows of synthetic loop pile tufts 24 extending upwardly from the backing sheet 22. The loop pile tuft length and thickness, the gauge between the rows, and the tufting rate between adjacent tufts in each row, will be sufficient to provide support for the synthetic turf layer while allowing passage of water laterally through the pile of the drainage layer. For example:
a stitch rate of about 180-280 stitches per meter;
a gauge of about ¼″;
a pile height of 3 and 9 mm, with about 5-7 mm being preferred.

Preferably the loop pile tufts 24 are made of a polypropylene yarn and stitched (tufted) into the backing sheet 22 in generally similar manner and using similar machinery to that used to produce the synthetic turf layer 12. It will be understood by those skilled in the art the loop pile tufts can be produced by plastics extrusion and subsequently secured to the backing sheet 22. Loop pile is preferred for the drainage layer, to provide optimal support and lateral stability for the synthetic turf layer above.

The backing sheet 22 is made of a latex-backed polypropylene material similar to the backing sheet of the top layer. The backing sheet 22 may be perforated or not, depending on the degree of water-permeability required, which will in turn depend on the nature of the base surface over which the drainage layer is laid. In the case of a relatively non-permeable base surface, such as concrete, or a base surface which is non-stable, eg. clay or surfaces prone to freezing, it is preferred not to perforate the backing sheet so as to result in low permeability. It will be noted that the process of stitching of the loop pile tufts 24 into the backing sheet 22 will necessarily result in some perforation of the backing sheet 22, and even with a latex backing layer a non-perforated backing sheet will have a permeability of approximately 5%.

For non-permeable or non-water-stable base surfaces, the backing sheet 22 preferably has a water-permeability of less than 10%, more preferably 3-5% of the total area of the backing sheet 22. It should be noted that while the above parameters are suitable for a tennis surface, in general, the required degree of perforation will depend on the intended use of the sports surface.

If the playing surface is for use over a stable, porous base layer, the backing sheet 22 of the drainage layer may be perforated in the manner described above for the synthetic turf layer 12. The perforations can be of arbitrary shape, although a circular shape would be preferable. The degree of perforation, i.e., the total surface of the openings compared to the total perforated backing sheet surface area, is a variable and can be selected to provide optimum drainage performance. The purpose of the perforations is to allow a fraction of the water (indicated by ‘A’) flowing through a water-permeable synthetic turf layer 12 disposed above the drainage system 14 to reach and be absorbed by the base surface 16. The bulk of the water (indicated by ‘B’) is drained laterally along the drainage space 30 formed by the loop pile tufts 24 and the backing sheet 22, away from the playing area. The distribution of water between fractions A and B can be controlled by the degree of perforation selected for the perforated backing sheet 22 and the desired distribution will depend on the nature of the solid substrate beneath the drainage layer. For example, a relatively high permeability will allow drainage both along the drainage layer and vertically into the base layer. Alternatively, a low drainage layer permeability of less than 10%, preferably about 5%, will permit minimal drainage into the base surface but permit some moisture to penetrate and thus prevent powdering or crumbling of a ‘real’ clay surface beneath the drainage layer, without water logging of the clay of the clay surface.

The synthetic turf layer 12 is attached to the drainage layer 14 at the seams in the turf layer, preferably by gluing the seaming tape (not shown) joining sections of the turf layer 12 to the loop pile 24 of the drainage layer 14.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein. It will further be understood that any reference herein to known prior art does not, unless the contrary indication appears, constitute an admission that such prior art is commonly known by those skilled in the art to which the invention relates.

1. A synthetic sports or recreation surface including: a drainage layer including a first flexible backing sheet and a plurality of synthetic tufts, said tufts being attached to and extending upwardly from said first backing sheet; a water-permeable synthetic turf layer disposed above the drainage layer, said turf layer including a second flexible backing sheet and a plurality of synthetic ribbons extending upwardly from said second backing sheet to provide a playing surface, said second backing sheet being water-permeable; attachment means for attaching said synthetic turf layer to said drainage layer; and a layer of a granular infill material filling the voids between the ribbons in the synthetic turf layer.

2. A synthetic sports or recreation surface according to claim 1 wherein said tufts in the drainage layer are loop pile tufts.

3. A synthetic sports or recreation surface according to claim 2 wherein said loop pile tufts are tufted into said first backing sheet.

4. A synthetic sports or recreation surface according to claim 3 wherein said tufts are arranged in parallel rows, said tufts being tufted into the first backing sheet at a gauge of about ¼″.

5. A synthetic sports or recreation surface according to claim 2 wherein the height of the loop pile tufts lies between 3 and 9 mm.

6. A synthetic sports or recreation surface according to claim 5 wherein said height is about 5-7 mm.

7. A synthetic sports or recreation surface according to claim 2 wherein said loop pile tufts are made of polypropylene, polyethylene or a polypropylene and polyethylene blend.

8. A synthetic sports or recreation surface according to claim 1 wherein said tuft material is the form of a yarn.

9. A synthetic sports or recreation surface according to claim 1 wherein said first backing sheet is latex-backed.

10. A synthetic sports or recreation surface according to claim 1 wherein the first backing sheet is less water-permeable than the second backing sheet.

11. A synthetic sports or recreation surface according to claim 1 wherein the first backing sheet has a water permeability of less than 10%.

12. A synthetic sports or recreation surface according to claim 11 wherein the first backing sheet has a water permeability of about 3-5%.

13. A synthetic sports or recreation surface according to claim 1 wherein said attachment means is a seaming tape.

14. A synthetic sports or recreation surface according to claim 1 wherein said second backing sheet is micro-perforated.

15. A synthetic sports or recreation surface according to claim 14 wherein said perforation is uniform.

16. A synthetic sports or recreation surface including: a drainage layer including a first flexible backing sheet and a plurality of synthetic tufts, said tufts being attached to and extending upwardly from said first backing sheet; a water-permeable synthetic grass layer disposed above the drainage layer, said grass layer including a second flexible backing sheet and a plurality of synthetic ribbons, representing blades of grass, said synthetic ribbons being attached to and extending upwardly from said second backing sheet, said backing sheet being water-permeable; and attachment means for attaching said synthetic grass layer to said drainage layer.

17. A synthetic sports or recreation surface according to claim 16 wherein said tufts in the drainage layer are loop pile tufts.

18. A synthetic sports or recreation surface according to claim 17 wherein said loop pile tufts are tufted into said first backing sheet.

19. A synthetic sports or recreation surface according to claim 18 wherein said tufts are arranged in parallel rows, said tufts being tufted into the first backing sheet at a gauge of about ¼″.

20. A synthetic sports or recreation surface according to claim 17 wherein the height of the loop pile tufts lies between 3 and 9 mm.

21. A synthetic sports or recreation surface according to claim 20 wherein said height is about 5-7 mm.

22. A synthetic sports or recreation surface according to claim 16 wherein said first backing sheet is latex-backed.

23. A synthetic sports or recreation surface according to claim 16 wherein the first backing sheet is less water-permeable than the second backing sheet.

24. A synthetic sports or recreation surface according to claim 16 wherein the first backing sheet has a water permeability of less than 10%.

25. A synthetic sports or recreation surface according to claim 24 wherein the first backing sheet has a water permeability of about 3-5%.

26. A synthetic sports or recreation surface according to claim 16 wherein said attachment means is a seaming tape.

27. A synthetic sports or recreation surface according to claim 16 wherein said second backing sheet is micro-perforated.

28. A synthetic sports or recreation surface according to claim 27 wherein said perforation is uniform.
